(19) United States
(12) Patent Application Publication
(10) Pub. No.: US 2022/0392292 A1
(43) Pub. Date: Dec. 8, 2022

(54) PAPER SHEET HANDLING APPARATUS

(71) Applicant: FUJITSU FRONTECH LIMITED, Tokyo (JP)

(72) Inventors: Atsushi ANDO, Inagi (JP); Tomoyuki TAMAHASHI, Inagi (JP); Satoshi HAYASHI, Inagi (JP); Shohei KOIZUMI, Inagi (JP); Shoichi DEGUCHI, Inagi (JP); Takashi WADA, Inagi (JP); Akira YAMADA, Inagi (JP)

(21) Appl. No.: 17/820,060

(22) Filed: Aug. 16, 2022

Related U.S. Application Data
(63) Continuation of application No. PCT/JP2020/007242, filed on Feb. 21, 2020.

(51) Int. Cl. G07D 11/14

(52) U.S. Cl. CPC G07D 11/14; G07D 2211/00; G07D 11/13

(57) ABSTRACT

A paper sheet handling apparatus includes a support member that is disposed so as to face a taking-out port in a taking-out space in which a paper sheet is taken out from the taking-out port, and supports a lower end of the paper sheet. The support member moves toward the taking-out port at a time when the paper sheet is taken out.

### CROSS-REFERENCE TO RELATED APPLICATION

This application is continuation application of International Application PCT/JP2020/007242 filed on Feb. 21, 2020 and designated the U.S., the entire contents of which are incorporated herein by reference.

### TECHNICAL FIELD

The present invention relates to a paper sheet handling apparatus.

### BACKGROUND ART

Heretofore, a banknote insertion/withdrawal apparatus has been proposed, which protrudes a bundle of banknotes from a banknote insertion/withdrawal port by sandwiching and conveying the bundle of banknotes by conveyor belts at the time when the banknotes are discharged from the banknote insertion/withdrawal port (for example, refer to Japanese Laid-open Patent Publication No. 59-11484 A).

Moreover, a banknote insertion/withdrawal apparatus has been proposed, which aligns a bundle of banknotes by vibrating side plates thereof in conjunction with up/down motions of a bottom plate thereof in contact with a lower end of the bundle of banknotes (for example, refer to Japanese Laid-open Patent Publication No. 61-101328 A).

### SUMMARY OF INVENTION

A paper sheet handling apparatus according to the disclosure includes a support member that is disposed so as to face a taking-out port in a taking-out space in which a paper sheet is taken out from the taking-out port, and supports a lower end of the paper sheet, wherein the support member moves toward the taking-out port at a time when the paper sheet is taken out.

The object and advantages of the present invention will be realized by the elements set forth in the claims or combinations thereof.

### BRIEF DESCRIPTION OF DRAWINGS

FIG. 1 is a left side view illustrating an internal configuration of an automatic transaction apparatus in an embodiment.

FIG. 2A is an explanatory view (No. 1) for explaining a banknote conveyance route of the automatic transaction apparatus in the embodiment.

FIG. 2B is an explanatory view (No. 2) for explaining the banknote conveyance route of the automatic transaction apparatus in the embodiment.

FIG. 2C is an explanatory view (No. 3) for explaining the banknote conveyance route of the automatic transaction apparatus in the embodiment.

FIG. 3A is an explanatory view (No. 1) for explaining a banknote inserting operation of a banknote insertion/withdrawal unit in the embodiment.

FIG. 3B is an explanatory view (No. 2) for explaining the banknote inserting operation of the banknote insertion/withdrawal unit in the embodiment.

FIG. 3C is an explanatory view (No. 3) for explaining the banknote inserting operation of the banknote insertion/withdrawal unit in the embodiment.

FIG. 3D is an explanatory view (No. 4) for explaining the banknote inserting operation of the banknote insertion/withdrawal unit in the embodiment.

FIG. 3E is an explanatory view (No. 5) for explaining the banknote inserting operation of the banknote insertion/withdrawal unit in the embodiment.

FIG. 4A is an explanatory view (No. 1) for explaining a banknote withdrawing operation of the banknote insertion/withdrawal unit in the embodiment.

FIG. 4B is an explanatory view (No. 2) for explaining the banknote withdrawing operation of the banknote insertion/withdrawal unit in the embodiment.

FIG. 5 is a perspective view illustrating a banknote receiving section in the embodiment.

### DESCRIPTION OF EMBODIMENTS

Incidentally, in an automatic transaction apparatus such as an automated teller machine (ATM), a banknote insertion/withdrawal unit is disposed in order to insert a banknote to be deposited and in order to take out a banknote to be withdrawn. In such a banknote insertion/withdrawal unit, a lower end of the banknote to be withdrawn is supported by a support member disposed so as to face the banknote insertion/withdrawal port.

A size of the banknote differs depending on a money type thereof, and accordingly, in the above-mentioned banknote insertion/withdrawal unit, when such a banknote with a minimum size is withdrawn, the banknote is visually hard to see from a customer, and the banknote is sometimes left behind.

Note that, in the banknote insertion/withdrawal apparatus that protrudes the bundle of banknotes from the banknote insertion/withdrawal port by the conveyor belts as mentioned above, the bundle of banknotes is sandwiched by the conveyor belts. Accordingly, the bundle of banknotes is caught by the conveyor belts, thus making it difficult to take out the bundle of banknotes.

By taking an automatic transaction apparatus 100 as an example, a description will be given of a paper sheet handling apparatus according to an embodiment of the present invention with reference to the drawings.

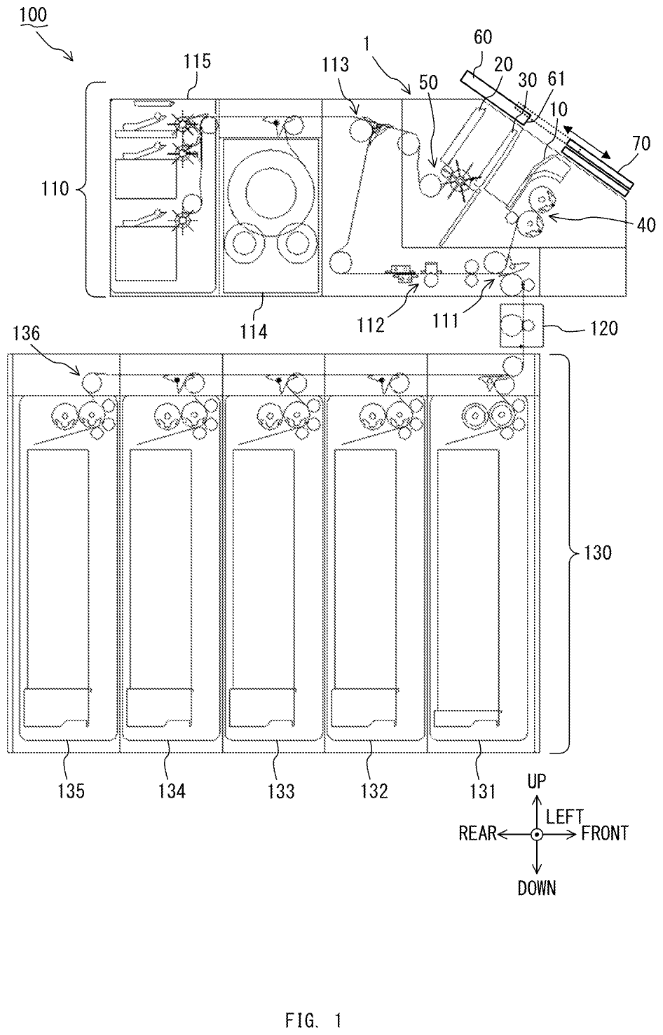

FIG. 1 is a left side view illustrating an internal configuration of the automatic transaction apparatus 100.

Note that up/down, front/rear and left/right directions illustrated in FIG. 1 and FIGS. 2A to 4B which will be mentioned later are merely examples in a case where a customer side of the automatic transaction apparatus 100 is in the front direction; however, for example, the up/down direction is a vertical direction, and the front/rear direction and the left/right direction are horizontal directions.

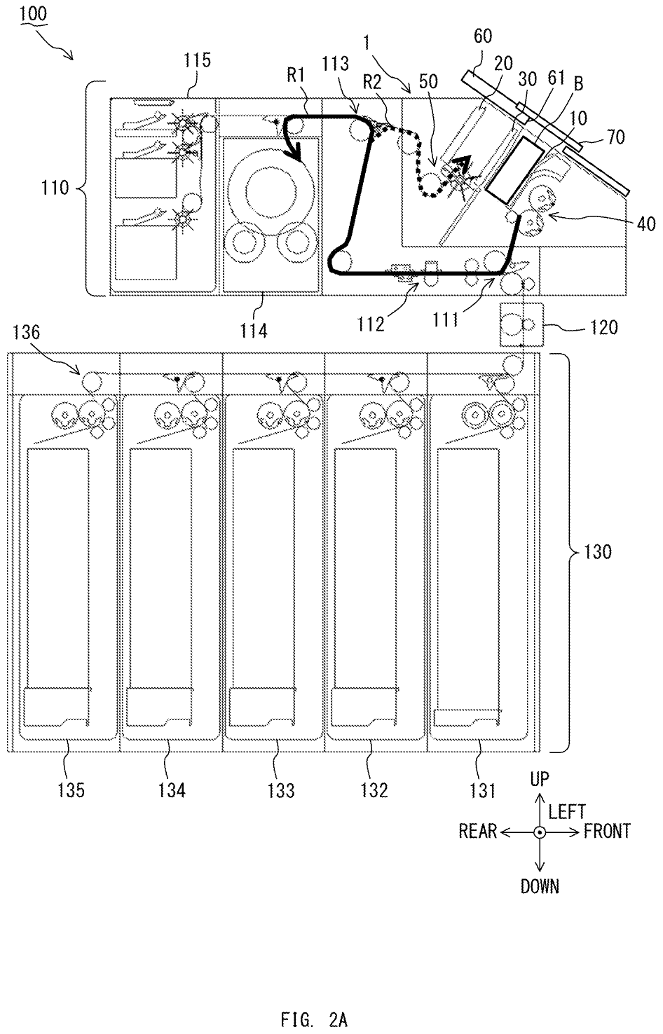

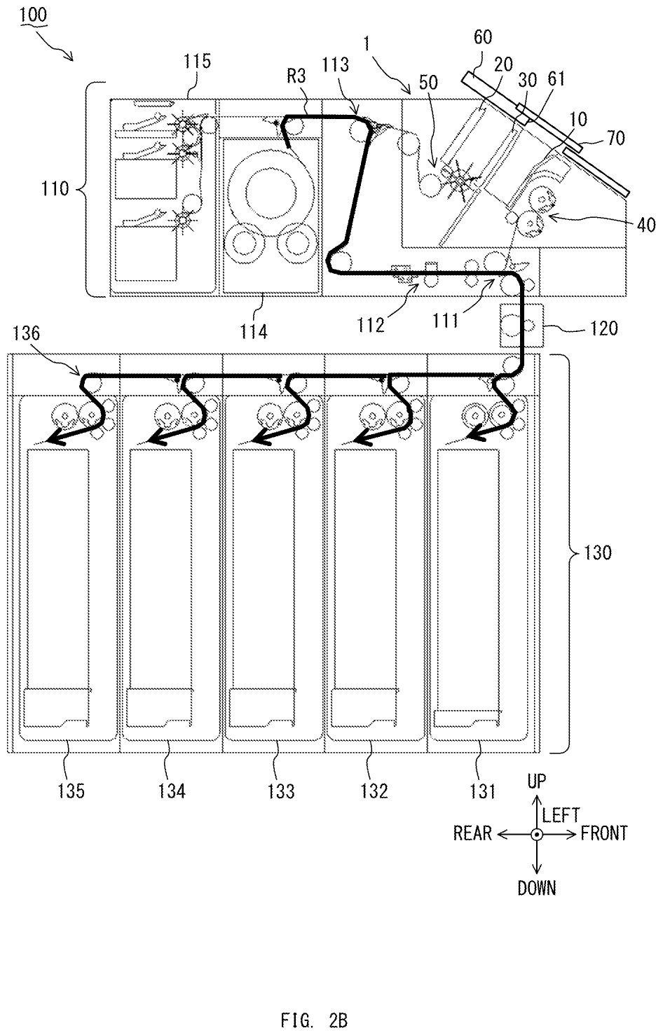

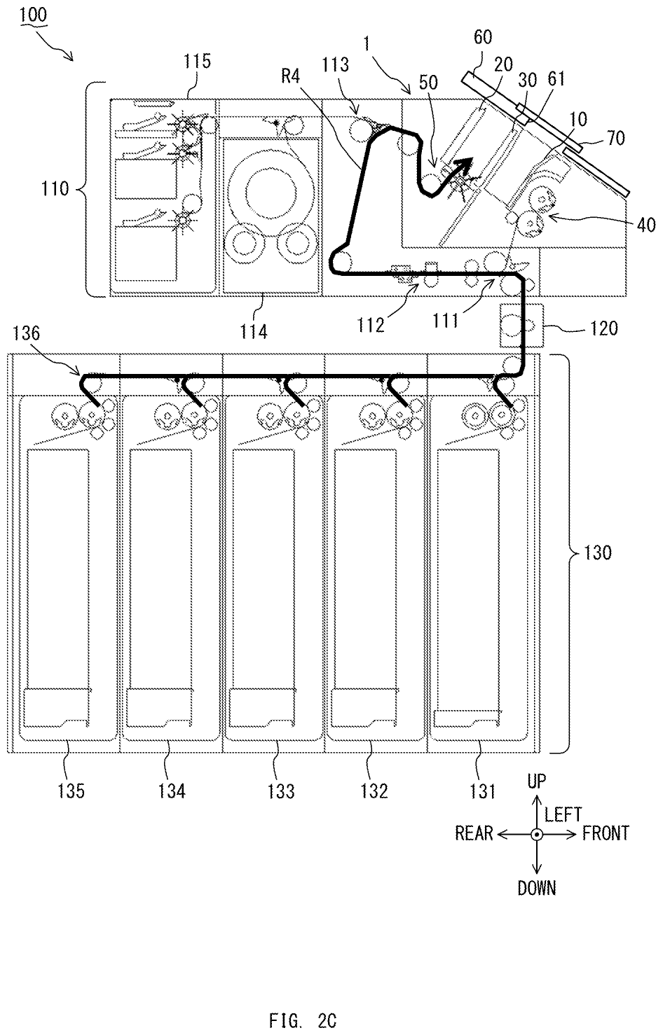

The automatic transaction apparatus 100 illustrated in FIG. 1 is, for example, an ATM, a bill recycle unit (BRU), a cash dispenser (CD), a teller cash recycler (TCR), or the like, and includes a main body unit 110, an intermediate conveyance section 120, and a storage unit 130. As an example, the main body unit 110 and the storage unit 130 are arranged in different spaces with a partition (not shown) interposed therebetween, and the intermediate conveyance section 120 conveys a banknote B (see FIG. 2A) so as to penetrate the above-described partition. Note that the banknote B is an example of paper sheets.

The main body unit 110 includes a banknote insertion/withdrawal unit 1, conveyance sections 111 and 113, an identification unit 112, a temporarily holding unit 114, and a reject unit 115.

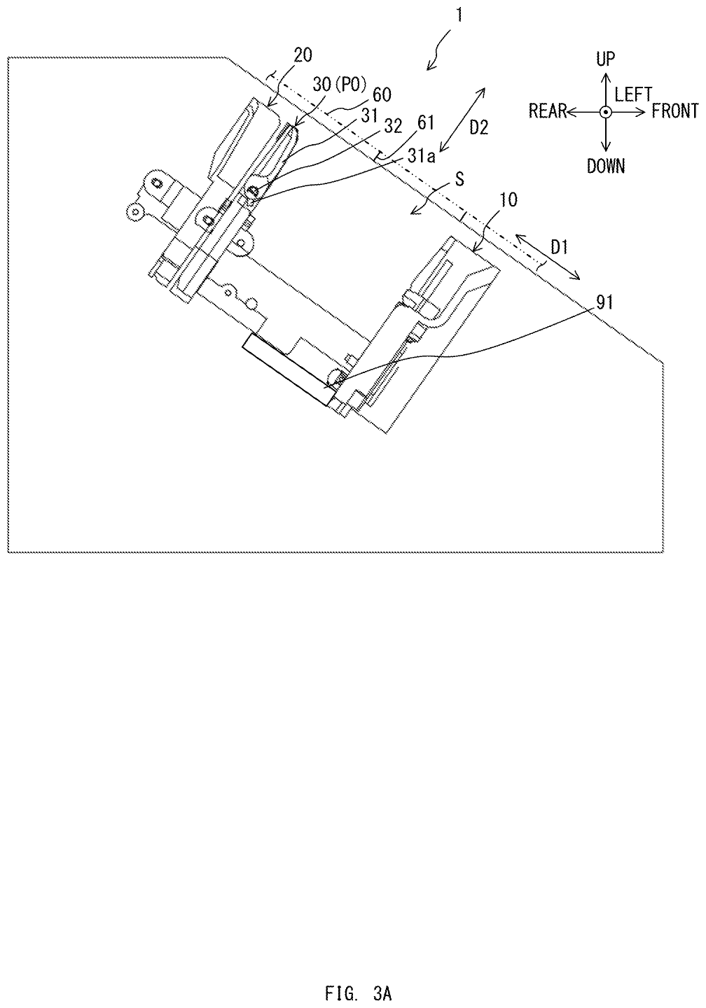

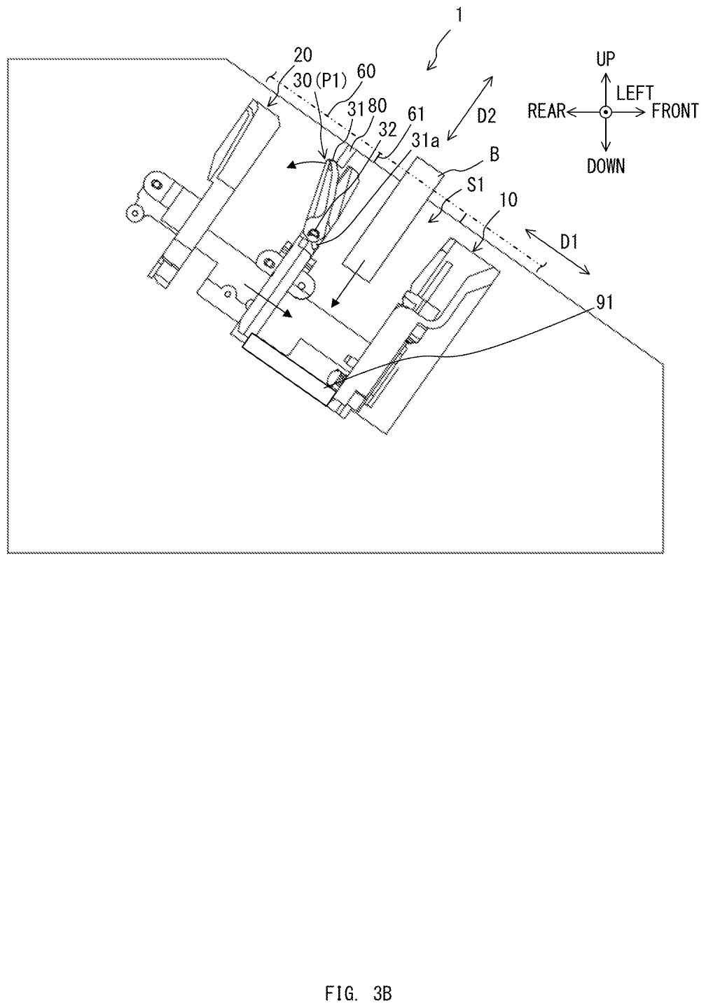

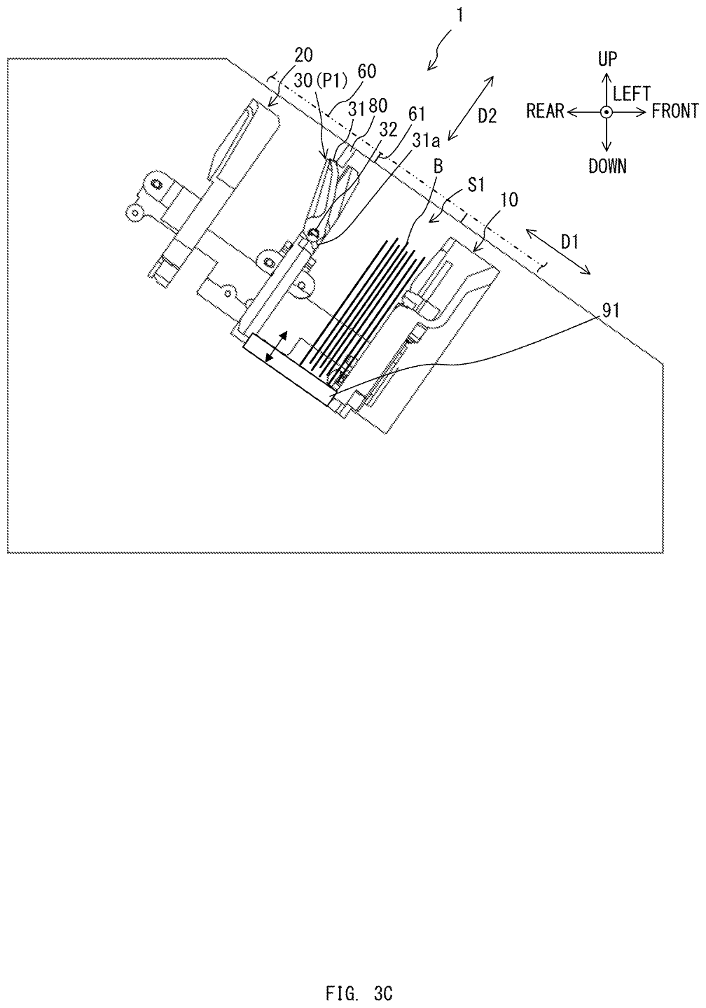

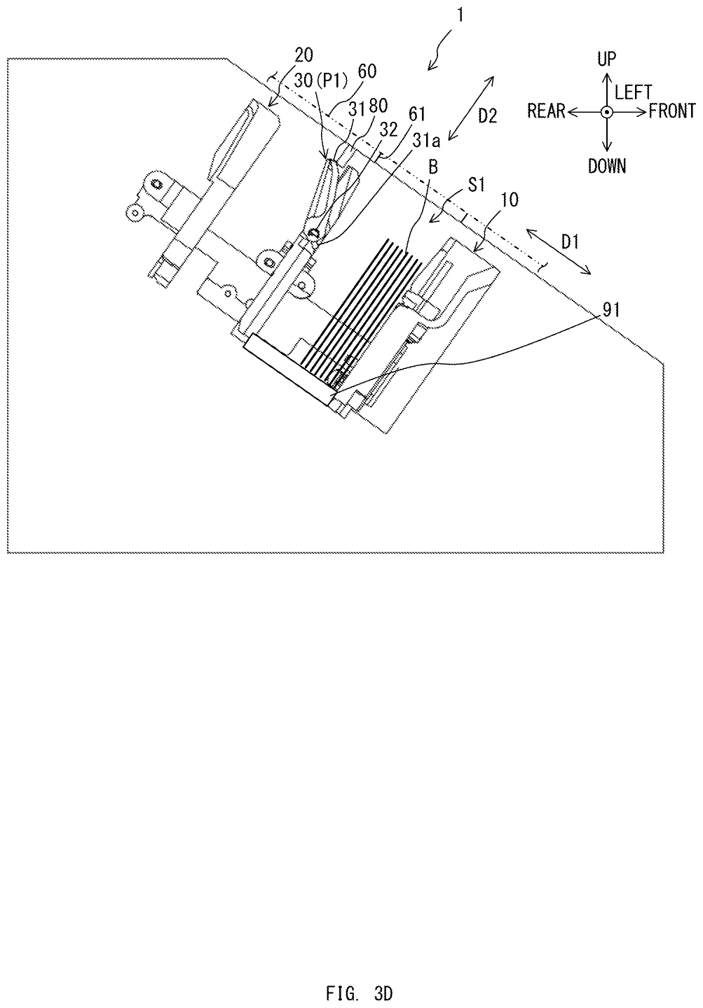

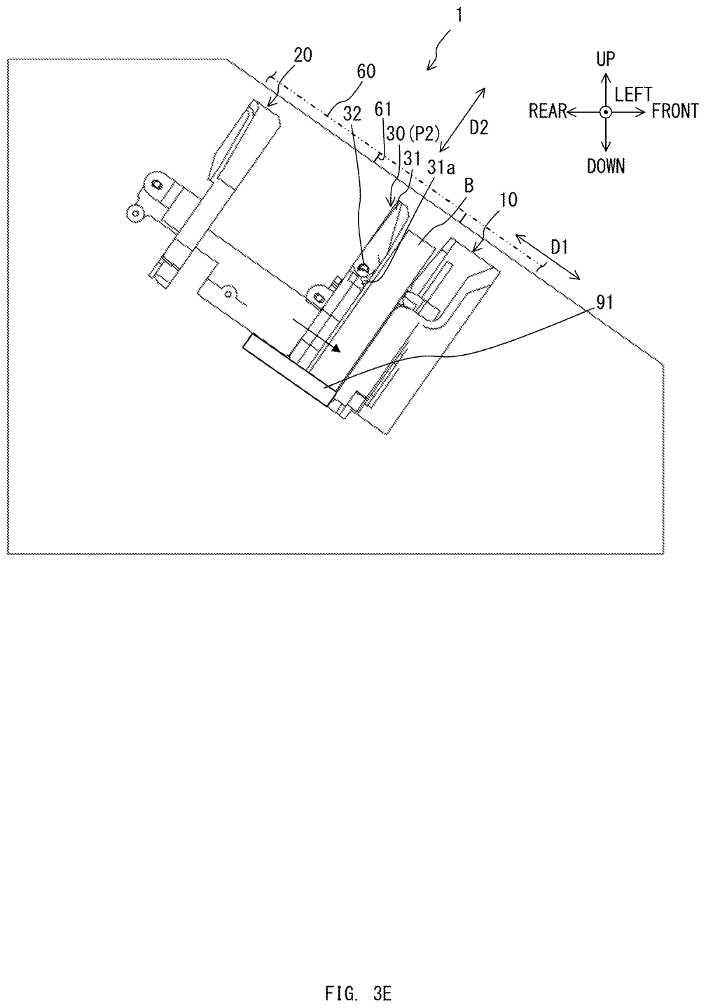

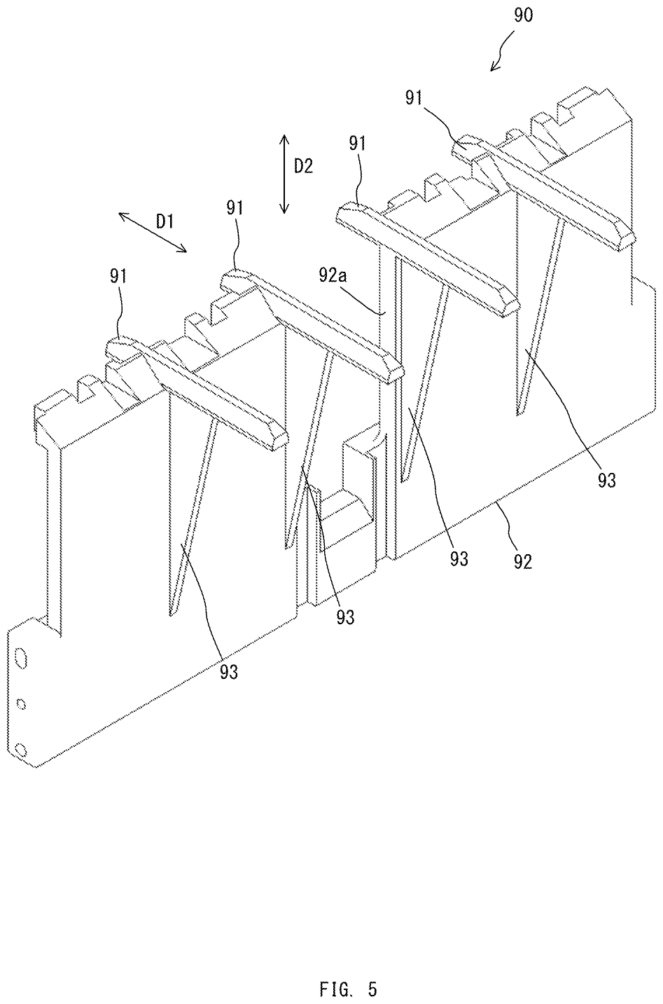

The banknote insertion/withdrawal unit 1 includes a stage 10, a roof 20, a pusher 30, a taking-in conveyance section 40, a discharge conveyance section 50, a front panel 60, a shutter 70, a first contact section 80 (see FIG. 3B), and a banknote receiving section 90 (see FIG. 5). Note that only the banknote insertion/withdrawal unit 1 may be regarded as an example of the paper sheet handling apparatus.

The stage 10, the roof 20, the pusher 30, the first contact section 80, and the banknote receiving section 90 will be described later with reference to FIGS. 3A to 3E, FIG. 4A, FIG. 4B, and FIG. 5.

The taking-in conveyance section 40 conveys the banknote B, which is inserted to between the stage 10 and the pusher 30, thereby taking the banknote B into the inside of the automatic transaction apparatus 100.

The discharge conveyance section 50 discharges the banknote B to between the roof 20 and the pusher 30.

On an upper front surface of the automatic transaction apparatus 100, the front panel 60 is disposed to be inclined with respect to the vertical direction and the horizontal direction so as to be located rearward as going upward. The front panel 60 is provided with an insertion/taking-out port 61. Note that the insertion/taking-out port 61 is an example of a taking-out port from which the banknote B is taken out. The insertion/taking-out port 61 serves as both of the taking-out port and an insertion port; however, the taking-out port and the insertion port may be provided at different positions.

The shutter 70 openably closes the insertion/taking-out port 61. Note that, in FIG. 1, the shutter 70 in an opened state is illustrated by a solid line, and the shutter 70 in a closed state is illustrated by a dotted line.

The conveyance section 111 conveys the banknote B from the banknote insertion/withdrawal unit 1 to the identification unit 112, and conveys the banknote B between the identification unit 112 and the intermediate conveyance section 120.

The identification unit 112 determines authenticity, dirt, corner bent and the like of the banknote B.

The conveyance section 113 conveys the banknote B between the identification unit 112 and the temporarily holding unit 114, and conveys the banknote B from the identification unit 112 to the banknote insertion/withdrawal unit 1.

The temporarily holding unit 114 temporarily stores the banknote B that is inserted into the banknote insertion/withdrawal unit 1 and determined to be normal in the identification unit 112.

The reject unit 115 stores a banknote B, which is not to be returned, among such banknotes B determined to be abnormal in the identification unit 112.

The intermediate conveyance section 120 conveys the banknote B between the main body unit 110 and the storage unit 130.

The storage unit 130 is disposed below the main body unit 110, and includes a plurality of banknote storage cassettes 131, 132, 133, 134, and 135, and a storage conveyance section 136.

The plurality of banknote storage cassettes 131 to 135 store, for example, such banknotes B of which money types are different from one another. The banknote storage cassettes 131 to 135 are capable of discharging the banknotes B stored therein. Therefore, the banknotes B stored in the banknote storage cassettes 131 to 135 are used for withdrawal.

The storage conveyance section 136 conveys the banknotes B between the intermediate conveyance section 120 and the respective banknote storage cassettes 131 to 135.

FIGS. 2A to 2C are explanatory views for explaining conveyance routes R1 to R4 of the automatic transaction apparatus 100 for the banknotes B.

First, as in the conveyance route R1 shown by a thick solid arrow in FIG. 2A, such banknotes B inserted into the banknote insertion/withdrawal unit 1 are conveyed to the identification unit 112 by the taking-in conveyance section 40 and the conveyance section 111. Moreover, such banknotes B determined to be normal in the identification unit 112 are conveyed to the temporarily holding unit 114 by the conveyance section 113.

Meanwhile, as in the conveyance route R2 shown by a thick dotted arrow in FIG. 2A, such banknotes B (counterfeit banknotes and the like) determined to be abnormal in the identification unit 112 are returned to the banknote insertion/withdrawal unit 1 by the conveyance section 113 and the discharge conveyance section 50.

As in the conveyance route R3 shown by a thick solid arrow in FIG. 2B, such banknotes B temporarily stored in the temporarily holding unit 114 are conveyed to the respective banknote storage cassettes 131 to 135 by the conveyance section 113, the identification unit 112, the conveyance section 111, the intermediate conveyance section 120, and the storage conveyance section 136.

As in the conveyance route R4 shown by a thick solid arrow in FIG. 2C, the banknotes B stored in the respective banknote storage cassettes 131 to 135 are discharged, at the time of withdrawal, to the banknote insertion/withdrawal unit 1 by the storage conveyance section 136, the intermediate conveyance section 120, the conveyance section 111, the identification unit 112, the conveyance section 113, and the discharge conveyance section 50.

Next, a description will be given of a banknote inserting operation and banknote withdrawing operation of the banknote insertion/withdrawal unit 1.

FIGS. 3A to 3E are explanatory views for explaining the banknote inserting operation of the banknote insertion/withdrawal unit 1.

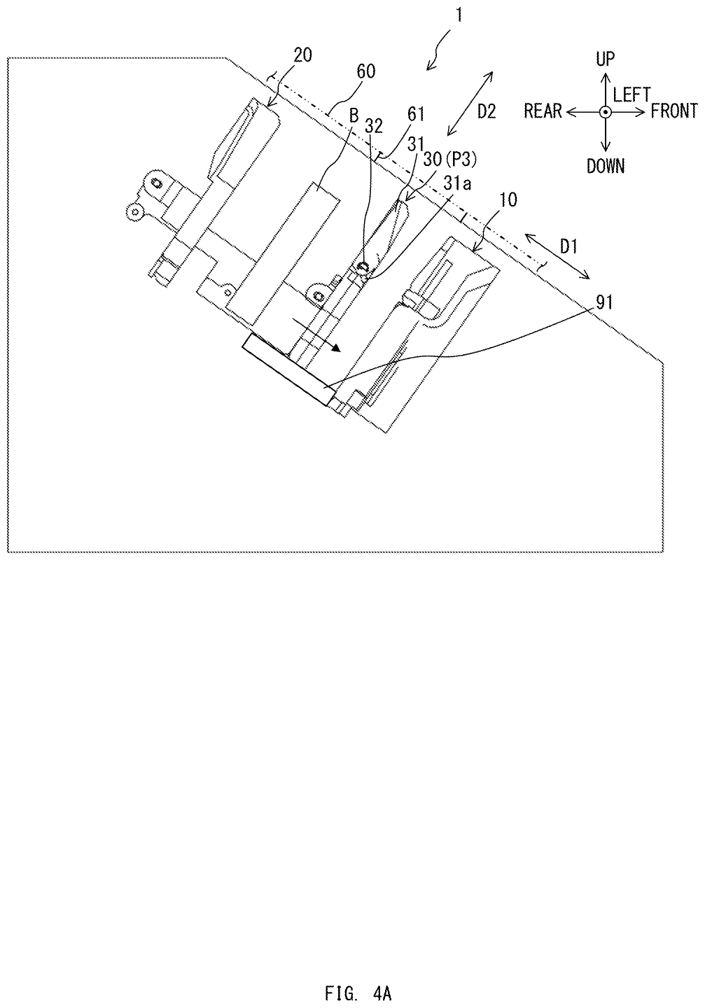

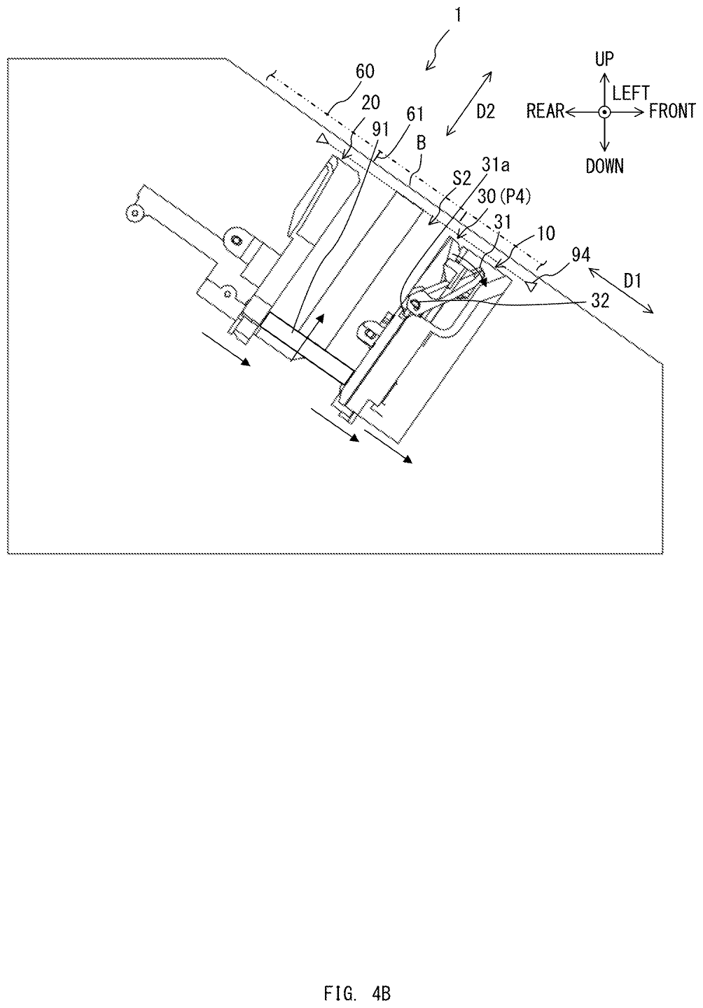

FIGS. 4A and 4B are explanatory views for explaining the banknote withdrawing operation of the banknote insertion/withdrawal unit 1.

FIG. 5 is a perspective view illustrating the banknote receiving section 90.

First, a description will be given of configurations of the stage 10, the roof 20, the pusher 30, the first contact section 80, and the banknote receiving section 90.

As illustrated in FIG. 3A, the stage 10 and the roof 20 are arranged so as to face each other with an insertion/taking-out space S interposed therebetween. Into this insertion/taking-out space S, the banknote B is inserted from the insertion/taking-out port 61 of the front panel 60, which is shown by a chain double-dashed line in each of FIGS. 3A to 4B, and in addition, the banknote B is taken out from the insertion/taking-out port 61.

In parallel to an insertion/taking-out direction D2 where the banknote B is inserted and taken out, the stage 10 and the roof 20 are arranged to be inclined in the vertical direction and the horizontal direction so as to be located upward as going forward. Therefore, a facing direction D1 where the stage 10 and the roof 20 face each other is perpendicular to the insertion/taking-out direction D2, and is inclined in the vertical direction and the horizontal direction so as to be located upward as going rearward.

The stage 10 and the roof 20 are movable in the facing direction D1. Note that the stage 10 is an example of a first facing section, and the roof 20 is an example of a second facing section.

The pusher 30 is an example of a partition section disposed between the stage 10 and the roof 20 so as to be movable in the facing direction D1 of the stage 10 and the roof 20. As illustrated in FIG. 3B, in the insertion/taking-out space S, the pusher 30 forms, with the stage 10, an insertion space S1 into which the banknote B is inserted from the insertion/taking-out port 61. Further, as illustrated in FIG. 4B, the pusher 30 forms, with the roof 20, a taking-out space S2 in which the banknote B is taken out from the insertion/taking-out port 61.

The pusher 30 includes a movable member 31 that is provided on a tip end thereof close to the insertion/taking-out port 61 and is movable toward both of the stage 10 (see FIG. 4B) and the roof 20 (see FIG. 3B). This movable member 31 is recommended to be provided, for example, on only a part of the vicinity of the center of the pusher 30 in the left/right direction that intersects the facing direction D1 and the insertion/taking-out direction D2.

The movable member 31 is supported so as to be rotatable about the rotating shaft 32 taken as a rotating center. Moreover, by an elastic body such as a torsion spring, the movable member 31 is recommended to be urged so as to continue to be parallel to the stage 10 and the roof 20. In the movable member 31, on an opposite side thereof to the insertion/taking-out port 61 with the rotating shaft 32 interposed therebetween, a pressed protrusion 31a that protrudes downward (toward the stage 10) is provided.

As illustrated in FIG. 3B, the first contact section 80 is a protrusion that is provided behind the insertion/taking-out port 61 and protrudes downward from the back surface of the front panel 60.

As illustrated in FIG. 5, the banknote receiving section 90 includes four support members 91, a base portion 92, and four reinforcement portions 93. The banknote receiving section 90 is disposed so as to be movable in the insertion/taking-out direction D2, that is, in the direction of approaching and separating from the taking-out port 61.

The support members 91 are arms which support a lower end of the banknote B. The support members 91 are arranged in the insertion/taking-out space S (an example of a taking-out space) so as to face the insertion/taking-out port 61 as illustrated in FIG. 3A.

The four support members 91 are fixed to the base portion 92. The base portion 92 is provided with a recessed portion 92a for avoiding interference with the pusher 30 illustrated in FIG. 3A.

In order to reinforce the support members 91, the four reinforcement portions 93 are provided between the respective support members 91 and the base portion 92, and exhibit a triangular plate shape.

A description will be given below of a flow of the banknote inserting operation and banknote withdrawing operation of the banknote insertion/withdrawal unit 1.

As illustrated in FIG. 3A, the pusher 30 is close to the roof 20 at an initial position P0 before the banknote B is inserted.

As illustrated in FIG. 3B, at an insertion position P1 at the time when the banknote B is inserted, the pusher 30 forms the insertion space S1 with the stage 10. At the time when the pusher 30 is located at the insertion position P1, the movable member 31 moves so as to be inclined toward the roof 20 by coming into contact with the first contact section 80 and being pressed against elastic force of the above-described elastic body. Thus, the insertion space S1 (between the pusher 30 and the stage 10) is widened toward the insertion/taking-out port 61, and accordingly, it is made easy for a customer to insert the banknote B. Note that the movable member 31 may move so as to be inclined toward the roof 20 by, for example, power of driving means (not shown).

Herein, in FIGS. 3C and 3D, such banknotes B are illustrated one by one.

As illustrated in FIG. 3C, the banknotes B inserted into the insertion space S1 from the insertion/taking-out port 61 are stored in the insertion space S1 while being inclined to the vertical direction, and accordingly, positions thereof are apt to vary. Particularly, when the banknotes B different in size are mixed due to different money types, the positions vary increasingly. Accordingly, the support members 91 (for example, the whole of the banknote receiving section 90 illustrated in FIG. 5) vibrate in the insertion/taking-out direction D2 (a direction of approaching and separating from the taking-out port 61), whereby the variations of the banknotes B are resolved as illustrated in FIG. 3D. Further, when a foreign object such as a coin is mixed together with the banknotes B due to the vibrations of the support members 91, the foreign object can be dropped off from gaps between the four support members 91 illustrated in FIG. 5.

Note that the support members 91 are recommended to vibrate by repeating an operation of approaching the insertion/taking-out port 61 at a certain approaching speed and separating from the insertion/taking-out port 61 at a speed higher than the approaching speed. A vibration amplitude of the support members 91 is arbitrary; however, is approximately 5 mm for example.

As illustrated in FIG. 3E, after the insertion of the banknotes B is completed, the pusher 30 moves the banknotes B to a sandwiching/taking-in position P2 toward the stage 10. Thereafter, for example, in a state where the stage 10 and the pusher 30 move toward the taking-in conveyance section 40 that is illustrated in FIG. 1 and located diagonally downward toward the front, and for example, the pick rollers of the taking-in conveyance section 40 protrude from the opening portions (not shown) provided in the stage 10, the banknotes B are conveyed toward the conveyance section 111 by the taking-in conveyance section 40.

At the time when the banknotes B are withdrawn, as illustrated in FIG. 4A, the discharge-scheduled number of banknotes B are conveyed to between the pusher 30 at a discharge position P3 and the roof 20 by the discharge conveyance section 50 illustrated in FIG. 1.

As illustrated in FIG. 4B, the pusher 30 moves toward the stage 10 together with the roof 20. At a taking-out position P4 at the time when the banknotes B are taken out, the pusher 30 forms the taking-out space S2 with the roof 20. When the pusher 30 is located at the taking-out position P4, the movable member 31 moves so as to be inclined toward the stage 10 in such a manner that the pressed protrusion 31a comes into contact with the stage 10 and is pressed against the elastic force of the above-described elastic body. Thus, the taking-out space S2 (between the pusher 30 and the roof 20) is widened toward the insertion/taking-out port 61, and accordingly, it is made easy for the customer to take out such a banknote B. Herein, the stage 10 functions as an example of a second contact section that moves the movable member 31 toward the stage 10 by coming into contact with the movable member 31.

Note that, as mentioned above, the movable member 31 may move so as to be inclined toward the stage 10 by, for example, the power of the driving means (not shown). Moreover, the movable member 31 may move so as to be inclined toward the stage 10 by coming into contact with a second contact section other than the stage 10. Further, the movable member 31 may come into contact with the stage 10 (the second contact section) by a portion thereof other than the pressed protrusion 31a.

Thereafter, the support members 91 (for example, the whole of the banknote receiving section 90 illustrated in FIG. 5) which support the lower ends of the banknotes B move toward the insertion/taking-out port 61. Then, the customer takes out the banknote B.

Herein, a movement amount of the support members 91 toward the insertion/taking-out port 61 may be constant, and in the vicinity of the insertion/taking-out port 61, a detection sensor 94 that detects an entry of a human hand (an example of a detection target) into the taking-out space S2 is disposed. Toward the insertion/taking-out port 61, the support members 91 are recommended to move to a position where the banknotes B are detected by the detection sensor 94. Note that, on the basis of sizes of the banknotes B, which are detected by the identification unit 112 illustrated in FIG. 1, the support members 91 are recommended to move toward the insertion/taking-out port 61 so that the movement amount of the banknote B with a larger size becomes smaller.

Moreover, by vibrations similar to those at the above-mentioned time of insertion, the support members 91 may resolve the positional variations of the banknotes B to be withdrawn.

In the above-described present embodiment, the automatic transaction apparatus 100 as an example of the paper sheet handling apparatus includes the support members 91 which support the lower ends of the banknotes B and are arranged, so as to face the insertion/taking-out port 61, in the taking-out space S2 in which the banknotes B (an example of the paper sheets) are taken out from the insertion/taking-out port 61 (an example of the taking-out port). At the time when the banknotes B are taken out, the support members 91 move toward the insertion/taking-out port 61.

Thus, even in the case where the banknote B with a minimum size is withdrawn, the banknote B can be made easy to see from the customer. Accordingly, such banknotes B can be prevented from being forgotten to be taken. Moreover, the support members 91 which support the lower ends of the banknotes B move toward the insertion/taking-out port 61, and accordingly, in comparison with an aspect (a comparative example) in which the banknotes B are conveyed toward the insertion/taking-out port 61, for example, in a state of being sandwiched by conveyor belts and the like, the customer can take out the banknotes B with ease.

Hence, in accordance with the present embodiment, it can be made easy to take out the banknotes B (paper sheets).

Moreover, in the present embodiment, the support members 91 vibrate in the direction (the insertion/taking-out direction D2) of approaching and separating from the insertion/taking-out port 61. Thus, the support members 91 can be vibrated using such a configuration of moving the support members 91 toward the insertion/taking-out port 61 in order to make it easy to take out the banknotes B as mentioned above, and accordingly, the configuration of the automatic transaction apparatus 100 can be simplified. Moreover, by the vibrations of the support members 91, the banknotes B in a state of being varied at the time of insertion can be aligned, and in addition, the foreign object mixed to the banknotes B can be removed.

Further, in the present embodiment, the automatic transaction apparatus 100 includes the detection sensor 94 that detects the entry of the detection target into the taking-out space S2, and at the time when the banknotes B are taken out, the support members 91 move to the position where the banknotes B in which the lower ends are supported by the support members 91 are detected by the detection sensor 94. Thus, irrespective of the sizes of the banknotes B, intervals between the insertion/taking-out port 61 and the banknotes B can be caused to coincide with one another. Hence, it can be made much easier to take out the banknotes B.

Note that the present invention is not limited to the above-mentioned embodiment as it is, and can be embodied by modifying components thereof. For example, a variety of inventions can be formed by appropriately combining the plurality of components disclosed in the present embodiment. As described above, varieties of modifications and applications can be made without departing from the spirit of the invention.

1. A paper sheet handling apparatus comprising:
a support member that is disposed so as to face a taking-out port in a taking-out space in which a paper sheet is taken out from the taking-out port, and supports a lower end of the paper sheet, wherein
the support member moves toward the taking-out port at a time when the paper sheet is taken out.

2. The paper sheet handling apparatus according to claim 1, wherein
the support member vibrates in a direction of approaching and separating from the taking-out port.

3. The paper sheet handling apparatus according to claim 1, further comprising
a detection sensor that detects an entry of a detection target into the taking-out space, wherein
the support member moves, at a time when the paper sheet is taken out, to a position where the paper sheet in which the lower end is supported by the support member is detected by the detection sensor.

4. The paper sheet handling apparatus according to claim 2, further comprising
a detection sensor that detects an entry of a detection target into the taking-out space, wherein
the support member moves, at a time when the paper sheet is taken out, to a position where the paper sheet in which the lower end is supported by the support member is detected by the detection sensor.
